(19) United States
(12) Patent Application Publication
(10) Pub. No.: US 2008/0100646 A1
(43) Pub. Date: May 1, 2008

(54) Display device and display panel driver using grayscale voltages which correspond to grayscales

(75) Inventor: Kenji Suzuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/905,812

(22) Filed: Oct. 4, 2007

(30) Foreign Application Priority Data
Oct. 25, 2006 (JP) 2006-289512

(51) Int. Cl. G09G 5/10

(52) U.S. Cl. 345/690

(57) ABSTRACT

A display device includes: a display panel; at least one data-line drivers; and a plurality of operational amplifiers. The plurality of operational amplifiers is integrated in any of the at least one data-line driver and generates a plurality of reference voltages, respectively. The data-line driver includes: a driving circuit, a maximum grayscale voltage wiring, and a resistance ladder. The driving circuit drives the display panel. The maximum grayscale voltage wiring receives a maximum reference voltage in the plurality of reference voltages from a first operational amplifier in the plurality of operational amplifiers and supplies the maximum reference voltage to the driving circuit as a maximum grayscale voltage. The resistance ladder receives the plurality of reference voltages except the maximum reference voltage from the plurality of operational amplifiers except the first operational amplifier, respectively, and generates a plurality of grayscale voltages lower than the maximum grayscale voltage. The driving circuit drives data lines of the display panel by using the maximum grayscale voltage and the plurality of grayscale voltages. The maximum grayscale voltage wiring is isolated from the resistance ladder.

### BACKGROUND OF THE INVENTION

1. Field of the Invention

The present invention relates to a display device, a display panel driver, and a display panel driving method. More particularly, the present invention relates to a technique for generating grayscale voltages which correspond to grayscales.

2. Description of Related Art

A display panel driver, which drives a liquid crystal display panel and other display panels by driving voltages, is often provided with a grayscale voltage generating circuit. The grayscale voltage generating circuit is a circuit for generating grayscale voltages which correspond to respective grayscales those can be used on the display panel. In a typical display panel driver, a grayscale voltage generated in the grayscale voltage generating circuit is selected based on a pixel data that show a grayscale of each pixel, and each pixel is driven by the selected grayscale voltage.

Japanese Laid-Open Patent Application JP-P-Heisei 6-161387 A (corresponding to U.S. Pat. No. 5,680,148 A) discloses a display device driving circuit which selectively outputs a plurality of grayscale reference voltages and interpolating voltages generated therefrom to data lines of a liquid crystal display panel. In this driving circuit, the grayscale reference voltages for obtaining the maximum grayscale and the minimum grayscale are controlled separately from the interpolating voltages. This improves a contrast of an image displayed on the liquid crystal display panel. However, this document does not disclose a method for generating the grayscale reference voltages.

Most typically, the grayscale voltage generating circuit is configured to generate the grayscale voltages by dividing voltages using a resistance ladder. Such grayscale voltage generating circuit is disclosed in Japanese Laid-Open Patent Application JP-P 2002-366112 A (corresponding to U.S. Pat. No. 7,023,458 B2), Japanese Laid-Open Patent Application JP-P 2004-126620 A (corresponding to U.S. Pat. No. 5,854,627 A), Japanese Laid-Open Patent Application JP-P 2005-265636 A, Japanese Laid-Open Patent Application JP-P 2006-39205 A (corresponding to US 2006022925 A1), and Japanese Laid-Open Patent Application JP-P 2006-78731 A (corresponding to US2006050036 A1), for example.

FIG. 1 is a circuit diagram showing a typical structure of a grayscale voltage generating circuit which generates grayscale voltages by using a resistance ladder. A grayscale voltage generating circuit 100 shown in FIG. 1 is composed of γ (gamma) amplifiers 101₁-101ₘ, and a resistance ladder 102.

Grayscale power supply voltages V_{E1} to V_{Em} satisfying a following relation are supplied to inputs of the γ amplifiers 101₁ to 101ₘ, respectively, from a grayscale power supply (not shown).

V_{E1}>V_{E2}> - - - >V_{Em}

In the meantime, outputs of the γ amplifiers 101₁ to 101ₘ are connected to input taps 103₁ to 103ₘ of the resistance ladder 102, respectively.

The resistance ladder 102 generates grayscale voltages V_{γ1} to V_{γP} that satisfy a following relation by dividing the voltages.

V_{γ1}>V_{γ2}> - - - >V_{γP}

### Resistance values between neighboring output taps of the resistance ladder 102 are determined in accordance with a gamma curve of a liquid crystal display panel.

In a liquid crystal display device of the early years, the resistance ladder 102 is integrated to a data-line driver, while the γ amplifiers 101₁-101ₘ are integrated to an exclusive-use IC that is different from the data-line driver. However, for reducing the cost, it is desired these days to integrate the γ amplifiers 101₁-101ₘ to the data-line driver. In a certain kind of a liquid crystal display device, the γ amplifiers 101₁-101ₘ are integrated to a single data-line driver. Further, in a case that a plurality of data-line drivers is provided with a liquid crystal display device, the resistance ladder 102 is integrated to the plurality of data-line drivers, respectively. Meanwhile, there may be cases where the resistance ladder 102 integrated to each of the plurality of data-line drivers is driven by a set of the γ amplifiers 101₁-101ₘ which are dispersedly integrated to the plurality of data-line drivers.

We have now discovered problems caused when integrating the γ amplifiers 101₁-101ₘ to the data-line driver. One of the problems is that a supply voltage supplied to the γ amplifiers 101₁-101ₘ fluctuates when the data-line driver drives the data lines of the liquid crystal display panel. The data lines of the liquid crystal display panel have large capacitances, so that a large drive current is required for driving the data lines. Thus, it is unavoidable for the supply voltage inside the data-line driver to fluctuate by a certain amount when the data lines are driven. However, in the grayscale voltage generating circuit 100 with a structure of FIG. 1, the voltages outputted from the γ amplifiers 101₁-101ₘ (that is, the voltages of the input taps 103₁-103ₘ) also fluctuate in accordance with the fluctuation in the supply voltage supplied to the γ amplifiers 101₁-101ₘ. As a result, the grayscale voltages V_{γ1}-V_{γP} fluctuate as well. Therefore, the quality of images displayed on the crystal display panel is deteriorated.

### SUMMARY

The present invention seeks to solve one or more of the above problems, or to improve upon those problems at least in part. In one embodiment, a display device includes: a display panel; at least one data-line drivers; and a plurality of operational amplifiers configured to be integrated in any of the at least one data-line driver and generate a plurality of reference voltages, respectively. The data-line driver includes: a driving circuit configured to drive the display panel; a maximum grayscale voltage wiring configured to receive a maximum reference voltage in the plurality of reference voltages from a first operational amplifier in the plurality of operational amplifiers and supply the maximum reference voltage to the driving circuit as a maximum grayscale voltage; and a resistance ladder configured to receive the plurality of reference voltages except the maximum reference voltage from the plurality of operational amplifiers except the first operational amplifier, respectively, and generate a plurality of grayscale voltages lower than the maximum grayscale voltage. The driving circuit drives data lines of the display panel by using the maximum grayscale voltage and the plurality of grayscale voltages. The maximum grayscale voltage wiring is isolated from the resistance ladder.

In the present invention, since the maximum grayscale voltage wiring is isolated from the resistance ladder, a source current and a sink current from/to an output of the operational amplifier can be reduced. The reduction of the source current and the sink current leads to improvement of the PSRR (Power Supply Rejection Ration) properties of the operational amplifier. Consequently, the operational amplifier can maintain stable output of the reference voltage even when the source voltage fluctuates. As a result, the grayscale voltage can be stabilized and the quality of images displayed on the display panel can be improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing a structure of a conventional grayscale voltage generating device;

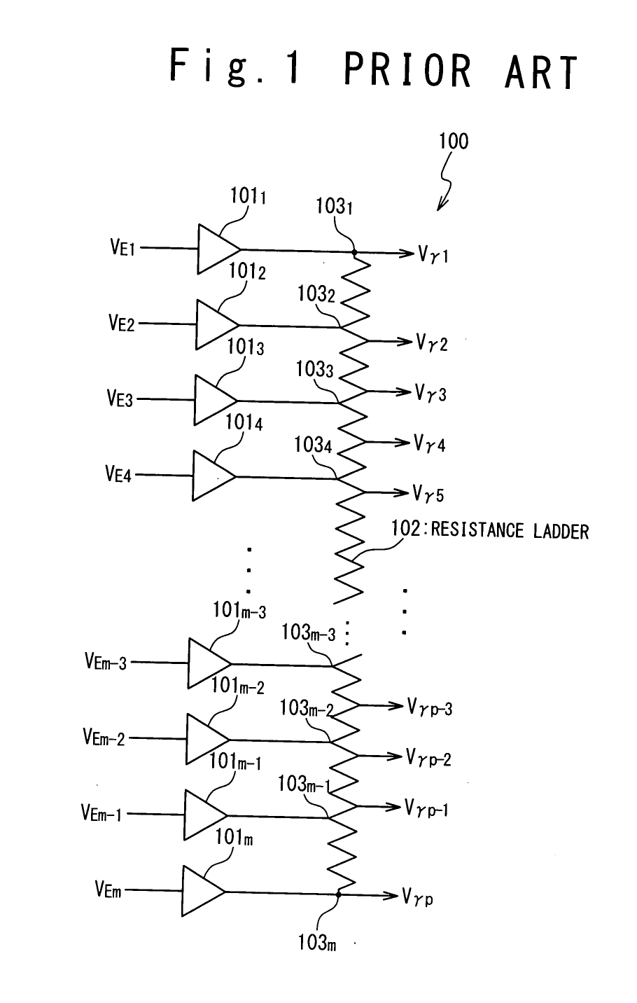

FIG. 2 is a block diagram showing a structure of a liquid crystal display device according to a first embodiment of the present invention;

FIG. 3 is a block diagram showing structures of a data-line driver and a grayscale power supply according to the first embodiment;

FIG. 4 is a circuit diagram showing a structure of a γ (gamma) resistance ladder circuit, and a connection mode between the γ resistance ladder circuit and γ amplifiers according to the first embodiment;

FIG. 5A is a circuit diagram showing a structure of a γ resistance ladder circuit, and a sink current/source current of γ amplifiers according to a typical example;

FIG. 5B is an illustration showing the structure of the γ resistance ladder circuit, and the sink current/source current of the γ amplifiers according to the first embodiment;

FIG. 6 is a graph showing fluctuations of reference voltages in the γ resistance ladder circuits according to the typical example and the present invention;

FIG. 7 is a schematic view showing an operation of the γ resistance ladder circuit in a case where a reference voltages V2 and Vₘ₋₁ are not supplied in the first embodiment;

FIG. 8 is a circuit diagram showing a structure of a γ resistance ladder circuit, and a connection mode between a γ resistance ladder circuit and γ amplifiers according to a second embodiment; and

FIG. 9 is a circuit diagram showing another connection mode between the γ resistance ladder circuit and the γ amplifiers according to the second embodiment.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Embodiments of a display device, a display panel driver, and a display panel driving method according to the present invention will be described below with reference to the attached drawings.

### First Embodiment

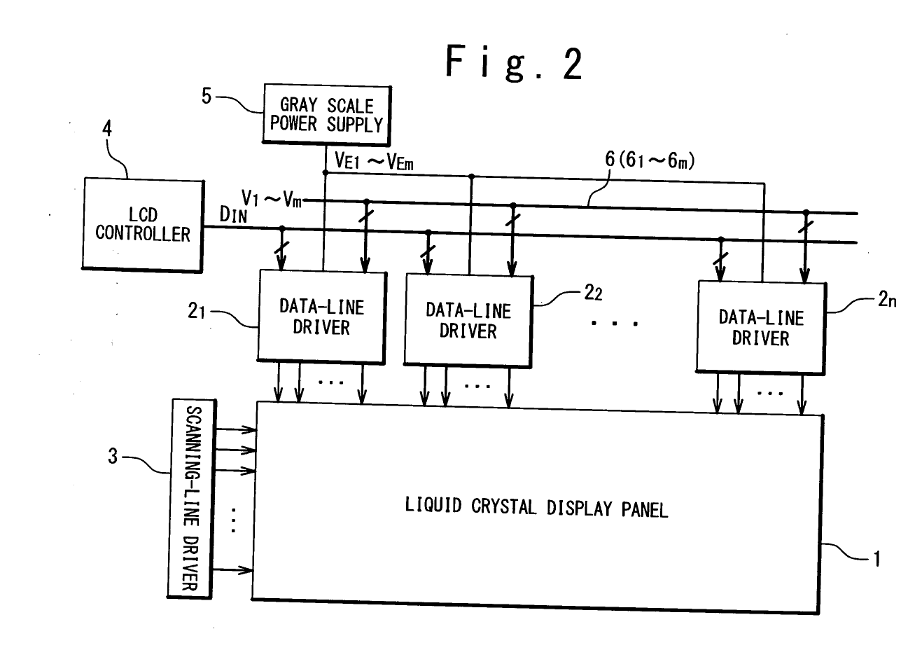

FIG. 2 is a block diagram showing a structure of a liquid crystal display device according to a first embodiment of the present invention. This liquid crystal display device includes: a liquid crystal display panel 1; data-line drivers 2₁ to 2ₙ; a scanning-line driver 3; an LCD controller 4; and a grayscale power supply 5. The data-line drivers 2₁ to 2ₙ drive data lines (not shown) of the liquid crystal display panel 1. The scanning-line driver 3 drives scanning lines (not show) of the liquid crystal display panel 1. The LCD controller 4 supplies pixel data D_{IN}, which show grayscales of respective pixels on the liquid crystal display panel 1, to the data-line drivers 2₁ to 2ₙ. In addition, the LCD controller 4 supplies control signals (not shown) to the data-line drivers 2₁ to 2ₙ and the scanning-line driver 3 so as to control the data-line drivers 2₁ to 2ₙ and the scanning-line driver 3 thereby.

The grayscale power supply 5 is a circuit for generating grayscale supply voltages V_{E1} to V_{Em}. As will be described later, the grayscale supply voltages V_{E1} to V_{Em} generated by the grayscale power supply 5 are a set of voltages used for generating reference voltages V₁ to Vₘ, which satisfy a following relation.

V_{E1}>V_{E2}> - - - >V_{Em}

### The reference voltages V₁ to Vₘ are supplied to the data-line drivers 2₁ to 2ₙ, respectively, through power supply lines 6 (6₁ to 6ₘ).

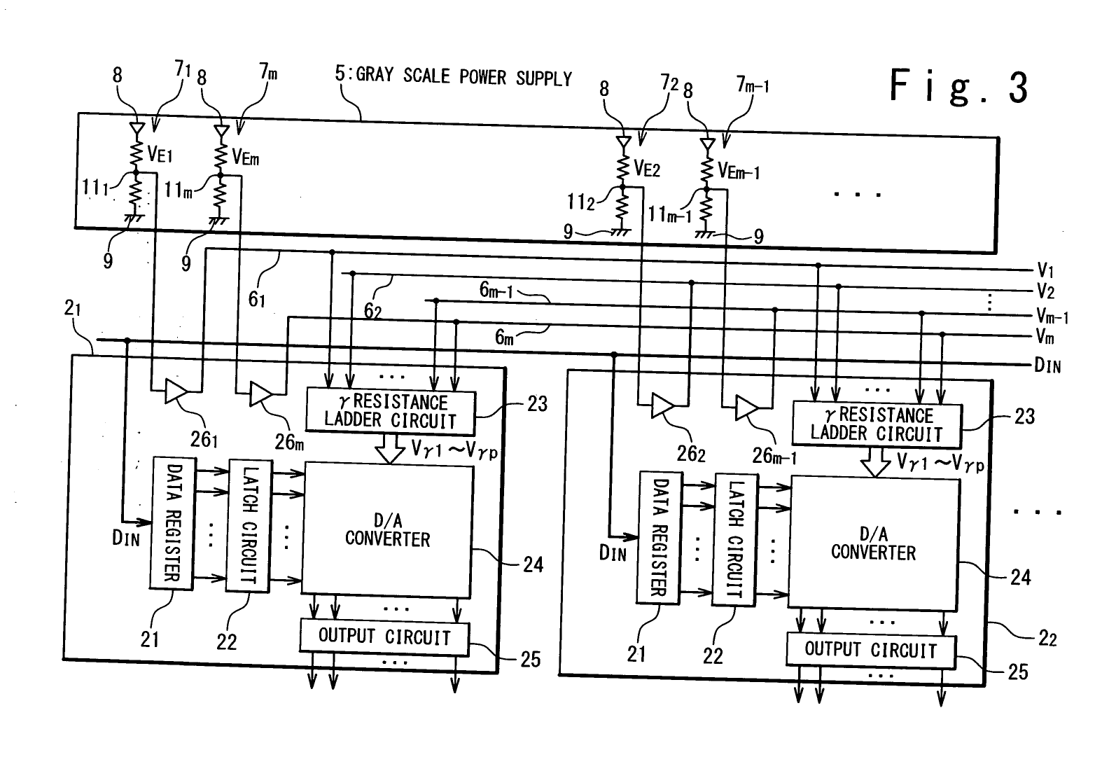

FIG. 3 is a block diagram showing structures of the data-line driver and the grayscale power supply according to the first embodiment. As shown in FIG. 3, the grayscale power supply 5 includes voltage dividing resistances 7₁ to 7ₘ which generate the grayscale supply voltages V_{E1} to V_{Em}, respectively. Each of the voltage dividing resistances 7₁ to 7ₘ is connected between a power supply terminal 8 and a ground terminal 9, and each of the voltage dividing resistances 7₁ to 7ₘ outputs the grayscale supply voltages V_{E1}-V_{Em} from an intermediate node 11₁ to 11ₘ provided in the middle thereof.

The power supply lines 6 are used for distributing the reference voltages V₁ to Vₘ, which are generated from the grayscale supply voltages V_{E1} to V_{Em}, to the data-line drivers 2₁ to 2ₙ, respectively. In FIG. 3, the power supply line 6 for distributing the reference voltage Vi to the data-line drivers 2₁ to 2ₙ is shown with a reference letter “6i”.

Subsequently, the structure of the data-line driver 2 will be described in detail. Each of the data-line drivers 2₁ to 2ₙ includes a data register 21, a latch circuit 22, a γ (gamma) resistance ladder circuit 23, a D/A converter 24, and an output circuit 25. The data register 21 receives the pixel data D_{IN} from the LCD controller 4 and stores it. The latch circuit 22 latches the pixel data D_{IN} from the data register 21, and transfers the latched pixel data D_{IN} to the D/A converter 24. The γ resistance ladder circuit 23 generates the grayscale voltages V_{γ1} to V_{γp}, which satisfy a following relation, from the reference voltages V₁ to Vₘ by dividing the voltages using the resistance ladder.

V_{γ1}>V_{γ2}> - - - >V_{γp}

The D/A converter 24 selects, from the grayscale voltages V_{γ1} to V_{γp}, a grayscale voltage that corresponds to each pixel data D_{IN} received from the latch circuit 22, and outputs the selected grayscale voltage to the output circuit 25. The output circuit 25 is composed of voltage followers (not shown), each of which is connected to corresponding one of the data lines of the liquid crystal display panel 1. Each of the voltage followers drives the corresponding one of the data lines to a drive voltage that corresponds to the grayscale voltage supplied from the D/A converter 24.

Further, γ (gamma) amplifiers 26₁ to 26ₘ are dispersedly integrated to the data-line drivers 2₁ to 2ₙ. The γ amplifiers 26₁ to 26ₘ are operational amplifiers used for generating the reference voltages V₁ to Vₘ from the grayscale supply voltages V_{E1} to V_{Em}, respectively. Basically, the γ amplifiers 26₁ to 26ₘ generate the reference voltages V₁ to Vₘ to correspond to the grayscale supply voltages V_{E1} to V_{Em}, respectively. However, it is also possible to perform fine adjustment of the reference voltages V₁ to Vₘ by the functions of the γ amplifiers 26₁ to 26ₘ. In the present embodiment, two γ amplifiers 26 are integrated to a single data-line driver 2 (therefore, m equals to 2n).

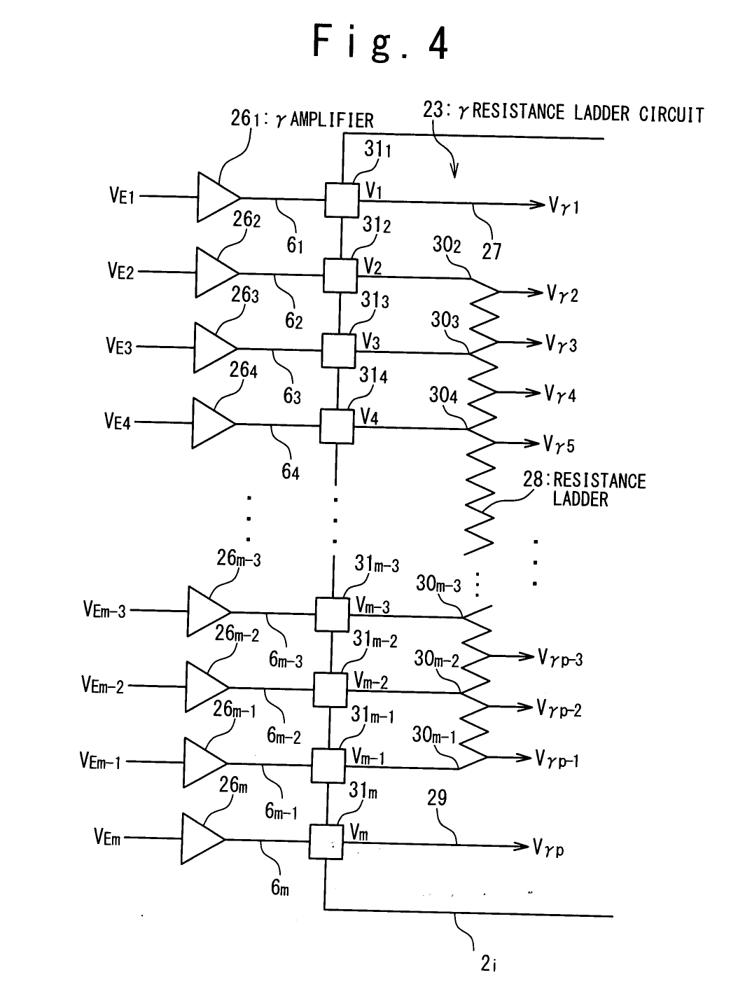

FIG. 4 is a circuit diagram showing a structure of the γ resistance ladder circuit 23 that is integrated to each of the data-line drivers 2. The γ resistance ladder circuit 23 includes the maximum grayscale voltage wiring 27, a resistance ladder 28, and a minimum grayscale voltage wiring 29. The maximum grayscale voltage wiring 27 is a wiring for supplying the maximum grayscale voltage V_{γ1} to the D/A converter 24, which is connected to an external input pad 31₁. The external input pad 31₁ is connected to an output of the γ amplifier 26₁ via the power supply line 6₁. Thus, the maximum grayscale voltage wiring 27 supplies the maximum reference voltage V₁, which is supplied from the γ amplifier 26₁ (as it is in the originally received state), to the D/A converter 24 as the maximum grayscale voltage V_{γ1}.

Similarly, the minimum grayscale voltage wiring 29 is a wiring for supplying the minimum grayscale voltage V_{γp} to the D/A converter 24, which is connected to an external input pad 31ₘ. The external input pad 31ₘ is connected to an output of the γ amplifier 26₁ via the power supply line 6ₘ. Thus, the minimum grayscale voltage wiring 29 supplies the minimum reference voltage Vₘ, which is supplied from the γ amplifier 26 (as it is in the originally received state), to the D/A converter 24 as the minimum grayscale voltage V_{γm.}

Meanwhile, the resistance ladder 28 generates intermediate grayscale voltages V_{γ2} to V_{γp-1} from the intermediate reference voltages V₂ to Vₘ₋₂ by dividing the voltages, respectively, and supplies those to the D/A converter 24. Input taps 30₂ to 30ₘ₋₁ are provided to the resistance ladder 28, and each of the input taps 30₂ to 30ₘ₋₁ is connected to corresponding one of external input pads 31₂ to 31ₘ₋₁. The external input pads 31₂ to 31ₘ₋₁ are connected to the γ amplifiers 26₂ to 26ₘ₋₂ via the power supply lines 6₂ to 6ₘ₋₁, respectively. Therefore, the reference voltages V₂ to Vₘ₋₁ are supplied to the input taps 30₂ to 30ₘ₋₁, respectively. When the reference voltages V₂ to Vₘ₋₁ are supplied, grayscale voltages V_{γ2} to V_{γp-1} are outputted from respective output taps of the resistance ladder 28.

One of the features of the liquid crystal display device 10 according to the embodiment is that the maximum grayscale voltage wiring 27 for supplying the maximum grayscale voltage V_{γ1} and the minimum grayscale voltage wiring 29 for supplying the minimum grayscale voltage V_{γp} are isolated from the resistance ladder 28. Through this, the output of the γ amplifier 26₁ which generates the maximum reference voltage V₁ and the output of the γ amplifier 26ₘ which generates the minimum grayscale voltage V_{γp} become isolated from the resistance ladder 28. Accordingly, source currents and sink currents from/to the outputs of the γ amplifiers 26₁, 26₂, 26ₘ₋₁, and 26ₘ which generate the reference voltages V₁, V₂, Vₘ₋₁, and Vₘ can be reduced. The reduction of the source current and the sink current stabilizes a current/voltage bias that is applied to transistors inside the γ amplifiers 26₁ to 26ₘ, and effectively improves PSRR (Power Supply Rejection Ratio) properties of the γ amplifiers 26₁ to 26ₘ. As a result, even if there is a fluctuation generated in the supply voltage supplied to the γ amplifiers 261 to 26m, the reference voltage can be maintained stably. Therefore, deterioration in the quality of the image displayed in the liquid crystal display panel can be suppressed.

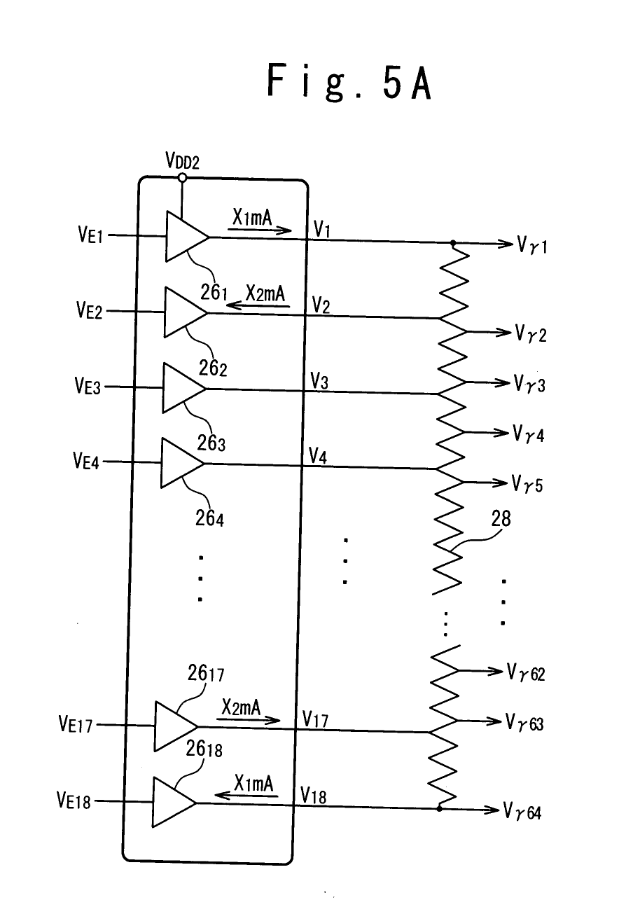

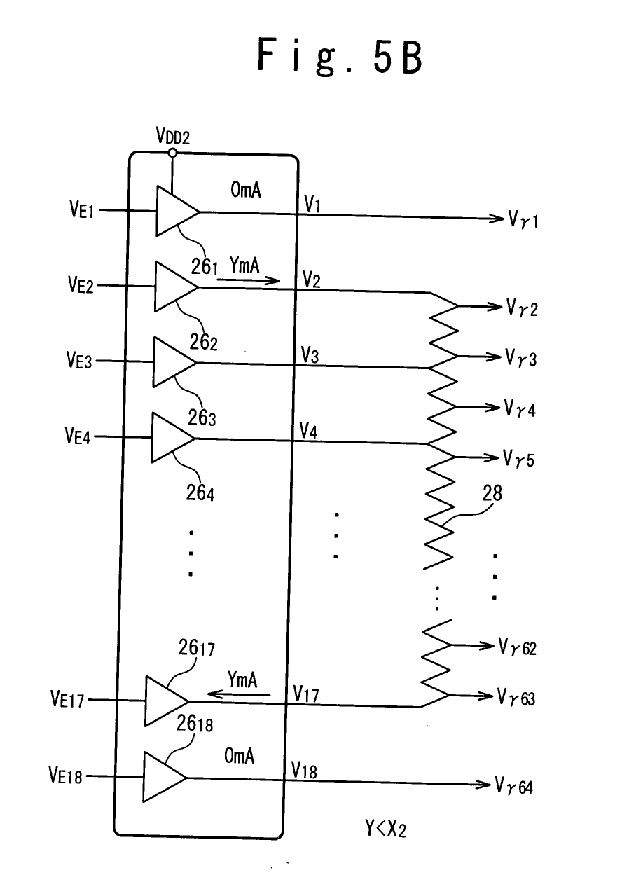

The inventors of the present invention investigated the effects of reducing the source current and the sink current and stabilizing the reference voltages by isolating the maximum grayscale voltage wiring 27 and the minimum grayscale voltage wiring 29 from the resistance ladder 28, through carrying out a simulation for a case where the number of the γ amplifiers 26 is eighteen (m 18). More specifically, the magnitudes of the source currents and the sink currents of the γ amplifiers 26₁, 26₂, 26ₘ₋₁, 26ₘ and the fluctuations of the reference voltages V₁, V₂ were calculated by the simulation for a case where outputs of the γ amplifier 26₁ and 26₁₈ were connected to the resistance ladder 28 (see FIG. 5A) and a case where the outputs of the γ amplifier 26₁ and 26₁₈ were not connected to the resistance ladder 28 (see FIG. 5B), respectively.

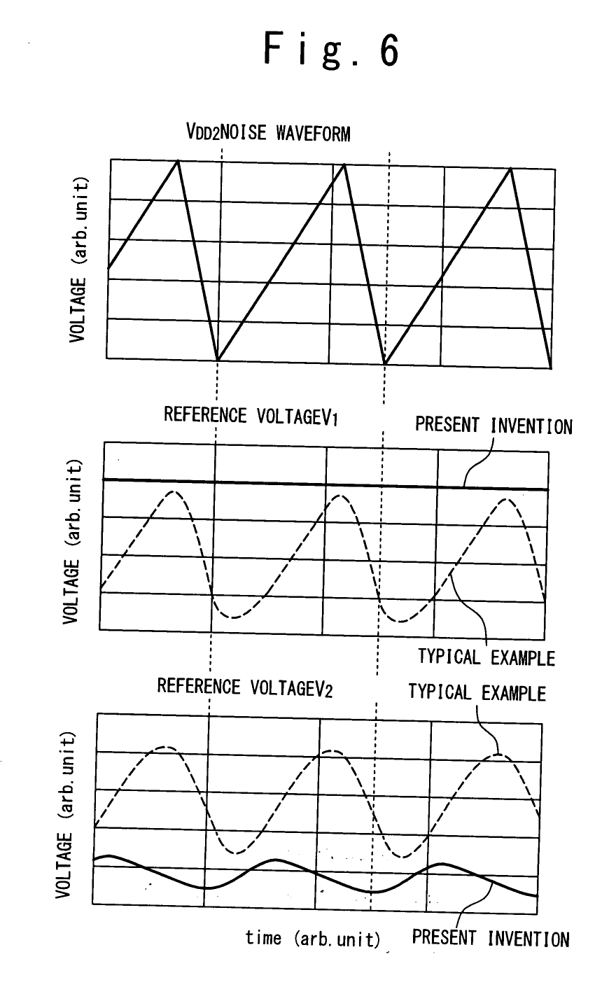

FIG. 5A is a circuit diagram showing a structure of the γ resistance ladder circuit, and the sink current/source current of the γ amplifier according to a typical example. FIG. 5B is a circuit diagram showing a structure of the γ resistance ladder circuit, and the sink current/source current of the γ amplifier according to a typical example and the first embodiment. FIG. 6 is a graph showing fluctuations of the reference voltages in the γ resistance ladder circuits according to the typical example and the first embodiment. As shown in FIG. 5A, when the maximum grayscale voltage wiring 27 and the minimum grayscale voltage wiring 29 were connected to the resistance ladder 28, the results obtained were as follows. That is, a relatively large source current (X₁ mA) flowed out from the output of the γ amplifier 26₁; a relatively large sink current (X₂ mA) flowed into the output of the γ amplifier 26₂; a relatively large source current (X₂ mA) flowed out from the output of the γ amplifier 26ₘ₋₁ (26₁₇); and a relatively large sink current (X₁ mA) flowed into the output of the γ amplifier 26ₘ (26₁₈). Further, as shown in FIG. 6, it was found as a result of the simulation that when the supply voltage V_{DD2} of the γ amplifier 26₁ to 26ₘ was periodically changed, the reference voltages V₁ and V₂ fluctuated largely as well.

Furthermore, a simulation was carried out under the same condition except that the maximum grayscale voltage wiring 27 and the minimum grayscale voltage wiring 29 were isolated from the resistance ladder 28, as shown in FIG. 5B. As a result, there was a remarkable reduction observed in the sink current and the source current of the γ amplifier 26₁, 26₂, 26₁₇, and 26₁₈. Specifically, as shown in FIG. 5B, following results were obtained. That is, the sink current and the source current of the γ amplifiers 26₁ and 26₁₈ were zero (0 mA); a relatively small source current (Y (<X₂) mA) flowed out from the output of the γ amplifier 26₂; and a relatively small sink current (Y mA) flowed into an output of the γ amplifier 26₁₇. Further, as shown in FIG. 6, it was found as a result of the simulation that the fluctuations of the reference voltages V₁ and V₂ were small even when the supply voltage V_{DD2} of the γ amplifiers 26₁ to 26ₘ was periodically changed.

The present embodiment presents the structure where the maximum grayscale voltage wiring 27 and the minimum grayscale voltage wiring 29 are both isolated from the resistance ladder 28. However, only one of those may be isolated electrically from the resistance ladder 28. It is obvious to those skilled in the art that the effects of reducing the sink current and the source current and suppressing the fluctuations of the reference voltages V₁, V₂ can also be obtained with such structure.

### Second Embodiment

Combinations of the reference voltages desired by manufactures of liquid crystal display devices may differ depending on each manufacture of the liquid crystal display devices. More specifically, a certain manufacture may desire to supply m-number of reference voltages V₁ to Vₘ to the data-line drivers, while another manufacture may desire to omit a supply of the second maximum reference voltage V₂ and the second minimum reference voltage Vₘ₋₁.

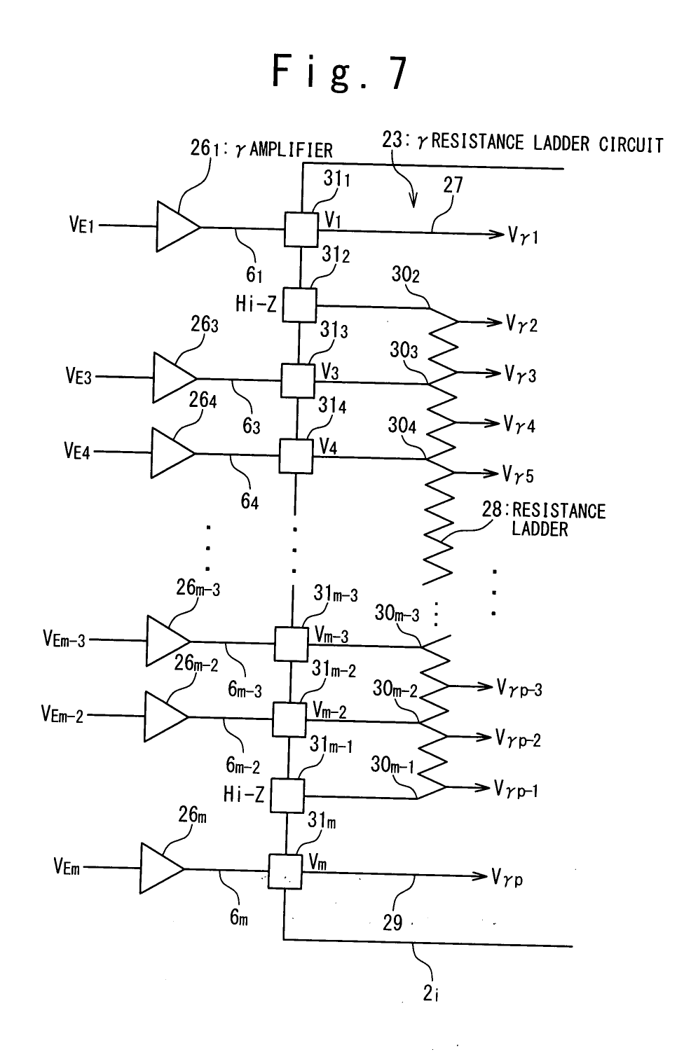

FIG. 7 is a schematic view showing an operation of the γ resistance ladder circuit in the case where the reference voltages V2 and Vₘ₋₁ are not supplied. The reference letters indicate the same elements as shown in FIG. 4. One of the problems for satisfying the demands of above both manufactures at the same time is that, as show in FIG. 7, a desired grayscale voltage cannot be generated with the structure of the γ resistance ladder circuit 23 of the first embodiment, if the supply of the reference voltages V₂ and Vₘ₋₁ is omitted. When the supply of the reference voltage V₂ is stopped, a desired grayscale voltage is not generated in an output tap between the input taps 30₂ and 30₃. Similarly, when the supply of the reference voltage Vₘ₋₁ is stopped, a desired grayscale voltage is not generated in the output tap between the input taps 30ₘ₋₁ and 30ₘ.

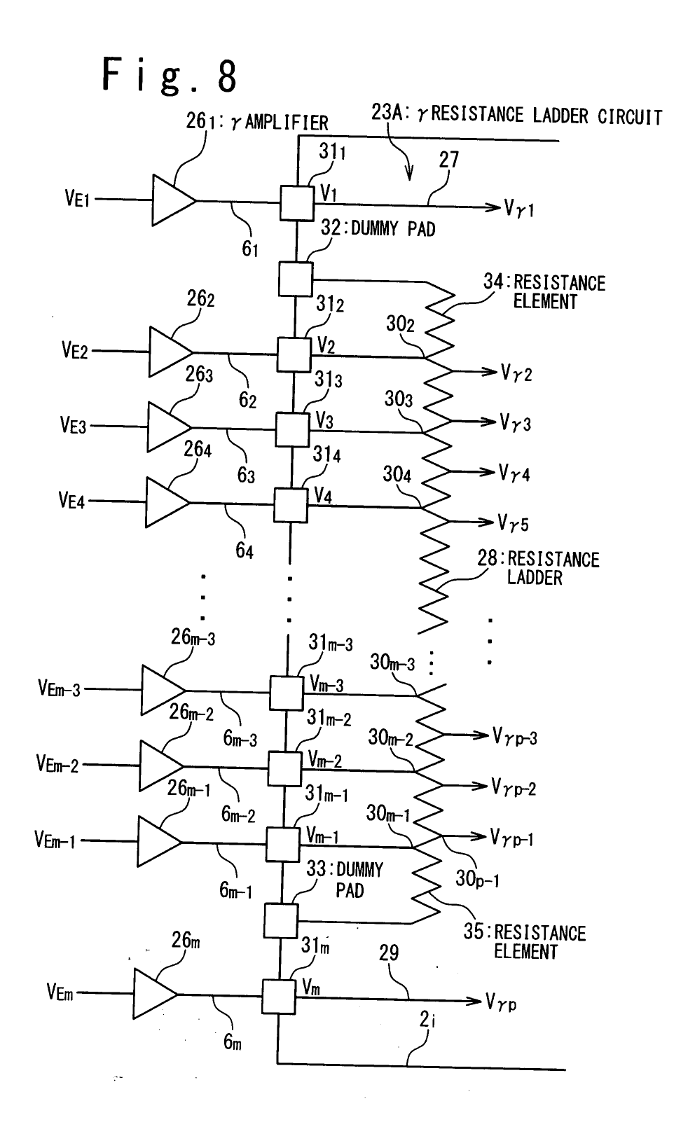

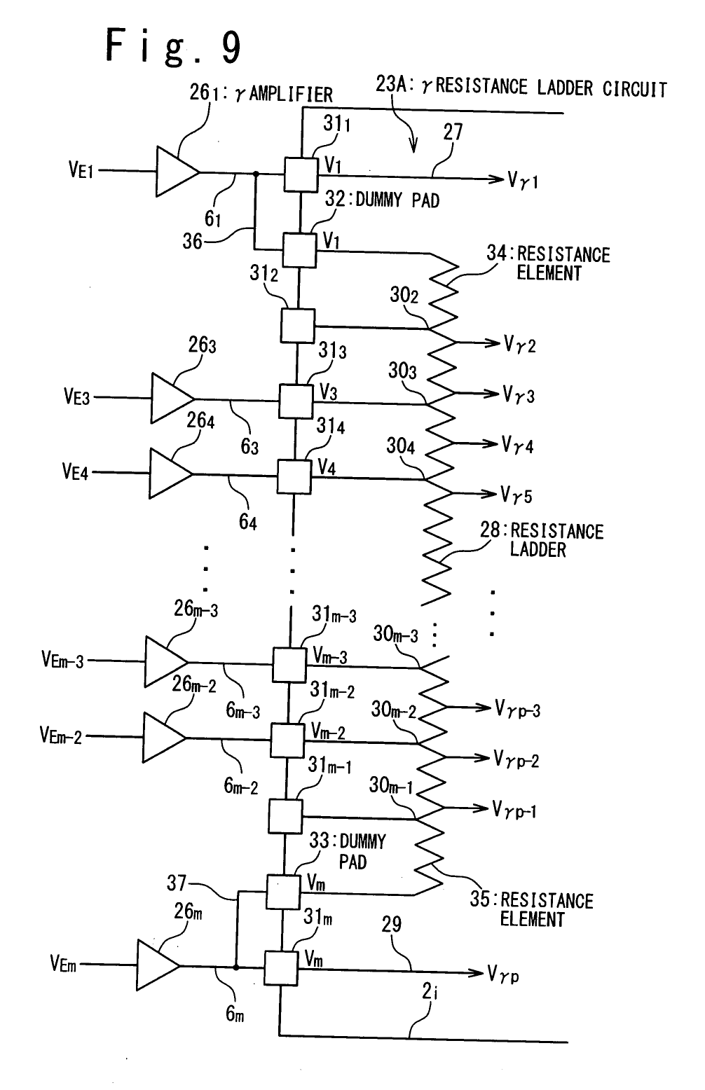

In order to solve such problems, the structure of the γ resistance ladder circuit loaded to each data-line driver 2 is modified in the second embodiment. FIGS. 8 and 9 are circuit block diagrams showing a structure of a γ resistance ladder circuit 23A according to the second embodiment of the present invention. In the second embodiment, each data line driver 2i is provided with dummy pads 32, 33, in addition to the external input pads 31₁ to 31ₘ which correspond to the power supply lines 6₁ to 6ₘ, respectively. The dummy pad 32 is connected to an input tap 30₂ of a resistance ladder 28 via a resistance element 34. The dummy pad 33 is connected to an input tap 30ₘ₋₁ of the resistance ladder 28 via a resistance element 35.

The γ resistance ladder circuit 23A with such structure can satisfy both the demand of the manufacture that desires to supply the reference voltages V₁ to Vₘ to all the data-line drivers and the demand of the manufacture that does not desire to supply the reference voltages V₂, Vₘ₋₁, through applying a small change in external wirings of the data-line drivers 2. As shown in FIG. 8, when all the reference voltages V₁ to Vₘ are to be supplied, the reference voltages V₁ to Vₘ are supplied to the external input pads 31₁ to 31ₘ, respectively.

In the meantime, when the supply of the reference voltages V₂ and Vₘ₋₁ are omitted, as shown in FIG. 9, the output of the γ amplifier 26₁ for generating the reference voltage V₁ is connected to the dummy pad 32 via an external wiring 36, and the output of the γ amplifier 26ₘ for generating the reference voltage Vₘ is connected to the dummy pad 33 via an external wiring 37. With this, the reference voltages V₁ and Vₘ are supplied to the dummy pads 32 and 33. When resistance values of the resistance elements 34, 35 are set properly, it is possible to generate desired grayscale voltages V_{γ2}-V_{γp-1} by supplying the reference voltages V₁, Vₘ to the dummy pads 32, 33, even if the reference voltages V₂, Vₘ₋₁ are not supplied.

In the embodiment described above, when the liquid crystal display panel 1 is driven by a single data-line driver 2, all the γ amplifiers 26₁ to 26ₘ may be integrated to the single data-line driver 2. In this case, the power supply lines 6₁ to 6ₘ for supplying the reference voltages V₁ to Vₘ to the resistance ladder 28 are also integrated to the single data-line driver 2.

Further, the above-described embodiment presents the liquid crystal display device that includes the liquid crystal display panel. However, it is obvious to those skilled in the art that the present invention can also be applied to display devices which voltage-drive other types of display panels.

According to the present invention, it is possible to improve qualities of images displayed on a display panel by stabilizing reference voltages generated by operational amplifiers and grayscale voltages generated therefrom.

It is apparent that the present invention is not limited to the above embodiment, but may be modified and changed without departing from the scope and spirit of the invention.

What is claimed is:

1. A display device comprising:
a display panel;
at least one data-line drivers; and
a plurality of operational amplifiers configured to be integrated in any of said at least one data-line driver and generate a plurality of reference voltages, respectively,
wherein said data-line driver includes:
a driving circuit configured to drive said display panel,
a maximum grayscale voltage wiring configured to receive a maximum reference voltage in said plurality of reference voltages from a first operational amplifier in said plurality of operational amplifiers and supply said maximum reference voltage to said driving circuit as a maximum grayscale voltage, and
a resistance ladder configured to receive said plurality of reference voltages except said maximum reference voltage from said plurality of operational amplifiers except said first operational amplifier, respectively, and generate a plurality of grayscale voltages lower than said maximum grayscale voltage,
wherein said driving circuit drives data lines of said display panel by using said maximum grayscale voltage and said plurality of grayscale voltages, and
said maximum grayscale voltage wiring is isolated from said resistance ladder.

2. The display device according to claim 1, further comprising:
a second operational amplifiers configured to be integrated in any of said at least one data-line drivers and generate a minimum reference voltage lower than any of said plurality of reference voltages,
wherein said data-line driver further includes:
a minimum grayscale voltage wiring configured to receive said minimum reference voltage from said second operational amplifier and supply said minimum reference voltage to said driving circuit as a minimum grayscale voltage,
wherein said driving circuit drives said data lines of said display panel by using said maximum grayscale voltage, said plurality of grayscale voltages and said minimum grayscale voltage, and
said minimum grayscale voltage wiring is isolated from said resistance ladder.

3. The display device according to claim 1, wherein said plurality of operational amplifiers outputs said plurality of reference voltages outside said at least one data-line drivers,
wherein said data-line driver further includes:
a plurality of pads configured to be connected to a plurality of input taps provided with said resistance ladder, respectively,
a dummy pad, and
a first resistance element configured to be provided between said dummy pad and an input tap which is positioned at end of said plurality of input taps,
wherein said dummy pad is connected to an output of said first operational amplifier through a wiring outside said data-line driver.

4. The display device according to claim 2, wherein said plurality of operational amplifiers outputs said plurality of reference voltages outside said at least one data-line drivers,
wherein said data-line driver further includes:
a plurality of pads configured to be connected to a plurality of input taps provided with said resistance ladder, respectively,
a first dummy pad,
a second dummy pad,
a first resistance element configured to be provided between said first dummy pad and an input tap which is positioned at one end of said plurality of input taps, and
a second resistance element configured to be provided between said second dummy pad and an input tap which is positioned at another end of said plurality of input taps,
wherein said first dummy pad is connected to an output of said first operational amplifier through a wiring outside said data-line driver, and
said second dummy pad is connected to an output of said second operational amplifier through a wiring outside said data-line driver.

5. A display device comprising:
a display panel;
at least one data-line drivers; and
a plurality of operational amplifiers configured to be integrated in any of said at least one data-line driver and generate a plurality of reference voltages, respectively,
wherein said data-line driver includes:
a driving circuit configured to drive said display panel,
a minimum grayscale voltage wiring configured to receive a minimum reference voltage in said plurality of reference voltages from a first operational amplifier in said plurality of operational amplifiers and supply said minimum reference voltage to said driving circuit as a minimum grayscale voltage, and
a resistance ladder configured to receive said plurality of reference voltages except said minimum reference voltage from said plurality of operational amplifiers except said first operational amplifier, respectively, and generate a plurality of grayscale voltages higher than said minimum grayscale voltage,
wherein said driving circuit drives data lines of said display panel by using said minimum grayscale voltage and said plurality of grayscale voltages, and
said minimum grayscale voltage wiring is isolated from said resistance ladder.

6. A display panel driver which is configured to generate a grayscale voltage from a plurality of reference voltages, comprising:
an operational amplifier configured to generate at least one of said plurality of reference voltages;
a driving circuit configured to drive a display panel;
a maximum grayscale voltage wiring configured to receive a maximum reference voltage of said plurality of reference voltages, and supply said maximum reference voltage to said driving circuit as a maximum grayscale voltage; and
a resistance ladder configured to receive said plurality of reference voltage except said maximum reference voltage, and generate a plurality of grayscale voltages lower than said maximum grayscale voltage,
wherein said driving circuit drives data lines of said display panel by using said maximum grayscale voltage and said plurality of grayscale voltages, and
said maximum grayscale voltage wiring is isolated from said resistance ladder.

7. The display panel driver according to claim 6, further comprising:
a minimum grayscale voltage wiring configured to receive a minimum reference voltage lower than any of said plurality of reference voltages, and supply said minimum reference voltage to said driving circuit as a minimum grayscale voltage,
wherein said driving circuit drives said data lines of said display panel by using said maximum grayscale voltage, said plurality of grayscale voltages and said minimum grayscale voltage, and
said minimum grayscale voltage wiring is isolated from said resistance ladder.

8. The display panel driver according to claim 6, further comprising:
a plurality of pads configured to be connected to a plurality of input taps provided with said resistance ladder, respectively,
a dummy pad, and
a first resistance element configured to be provided between said dummy pad and an input tap which is positioned at end of said plurality of input taps.

9. The display panel driver according to claim 8, wherein said dummy pad is connected to an output of an operational amplifier supplying said maximum reference voltage through an outside wiring.

10. The display panel driver according to claim 7, further comprising:
a plurality of pads configured to be connected to a plurality of input taps provided with said resistance ladder, respectively,
a first dummy pad,
a second dummy pad,
a first resistance element configured to be provided between said first dummy pad and an input tap which is positioned at one end of said plurality of input taps, and
a second resistance element configured to be provided between said second dummy pad and an input tap which is positioned at another end of said plurality of input taps.

11. The display panel driver according to claim 10, wherein said first dummy pad is connected to an output of an operational amplifier supplying said maximum reference voltage through an outside wiring, and
said second dummy pad is connected to an output of an operational amplifier supplying said minimum reference voltage through an outside wiring.
